(19) United States
(12) Patent Application Publication
(10) Pub. No.: US 2015/0268694 A1
(43) Pub. Date: Sep. 24, 2015

(54) ELECTRONIC APPARATUS

(71) Applicant: Kabushiki Kaisha Toshiba, Tokyo (JP)

(72) Inventors: Shinji Hiratomo, Tokyo (JP); Masataka Tokoro, Tokyo (JP)

(21) Appl. No.: 14/483,441

(22) Filed: Sep. 11, 2014

(30) Foreign Application Priority Data
Mar. 24, 2014 (JP) 2014-060468

(51) Int. Cl. G06F 1/16

(52) U.S. Cl. CPC G06F 1/1616; G06F 1/1654; G06F 1/1669

(57) ABSTRACT

According to one embodiment, an electronic apparatus includes a device body with a bottom wall, a tilt structure at the bottom wall configured to support the device body on a mounting surface with being inclined at a tilt angle to the mounting surface, and a support stand at the device body configured to be movable in a direction parallel to the mounting surface between a stored position wherein the support stand is housed in device body and a pulled out position wherein the support stand is pulled out rearward from the rear part of the device body to support the device body.

### CROSS-REFERENCE TO RELATED APPLICATIONS

This application is based upon and claims the benefit of priority from Japanese Patent Application No. 2014-060468, filed Mar. 24, 2014, the entire contents of which are incorporated herein by reference.

### FIELD

Embodiments described herein relate generally to an electronic apparatus.

### BACKGROUND

A piece of electronic apparatus, for instance, a notebook type portable computer (PC) has a flat device body and a display unit attached to the device body in a rotatable manner. The device body has a keyboard on its top surface. Recently, there is proposed an electronic apparatus wherein the display unit is formed of a tablet type PC and the device body is formed of a keyboard dock. The electronic apparatus can be used as a notebook type PC by connecting the tablet type PC to the keyboard dock.

When such a PC is used, the device body is placed on the desk and the like, and the display unit is raised. When the tablet type PC is used as a display unit, the PC tends to tip over, since the tablet type PC is relatively heavy and thus causes the device body to be lifted up when the tablet type PC is made to open or rotated.

When an upper part of the tablet type PC is touched while the tablet type PC is in an open state, the front part of the device body tends to be raised and thus the PC tends to tip over. There is proposed a PC wherein a tilt feature is provided at the device body to prevent the PC from tipping over.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating a notebook-type portable computer as an electronic apparatus in an embodiment;

FIG. 2 is a perspective view of the potable computer as seen from the rear;

FIG. 3 is an exploded perspective view of the portable computer in which a display unit is taken off;

FIG. 4 is a plan view illustrating a bottom of the device body in a state that a support stand is housed;

FIG. 5 is a plan view illustrating the bottom of the device body in a state that the support stand is pulled out;

FIG. 6 is a perspective view illustrating the rear part of the portable computer in a state that the support stand is pulled out;

FIG. 7 is a perspective view illustrating the rear part of the bottom of the portable computer in a state that the support stand is pulled out;

FIG. 8 is an exploded perspective view of a disassembled support stand;

FIG. 9 is a side view of the portable computer in which the support stand is in a housed position and is illustrated in a partially cut away state; and

FIG. 10 is a side view of the portable computer in which the support stand is in a pulled out position and is illustrated in a partially cut away state.

### DETAILED DESCRIPTION

Various embodiments will be described hereinafter with reference to the accompanying drawings. In general, according to one embodiment, an electronic apparatus comprises a device body comprising a bottom wall and a rear wall, and a plurality of legs on the bottom wall configured to support the device body on a mounting surface at a tilt angle to the mounting surface; a display rotatably supported on the device body; and a support stand in the device body configured to be movable in a direction substantially parallel to the mounting surface between a stored position wherein the support stand is housed in the device body and a pulled out position wherein the support stand is pulled out rearward from the rear wall of the device body to support the device body.

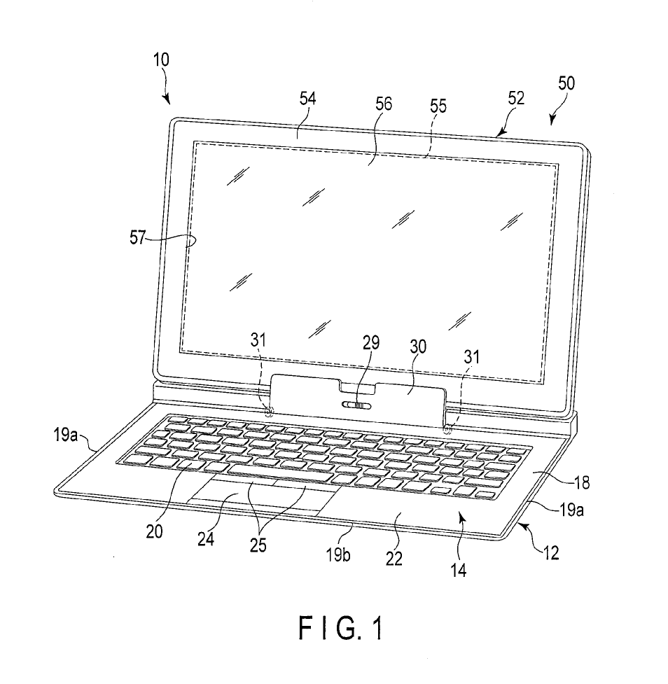

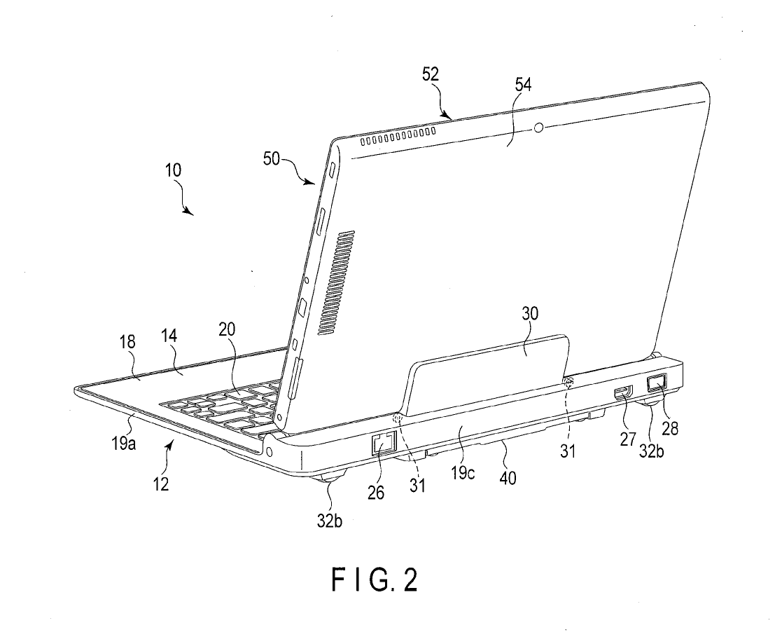

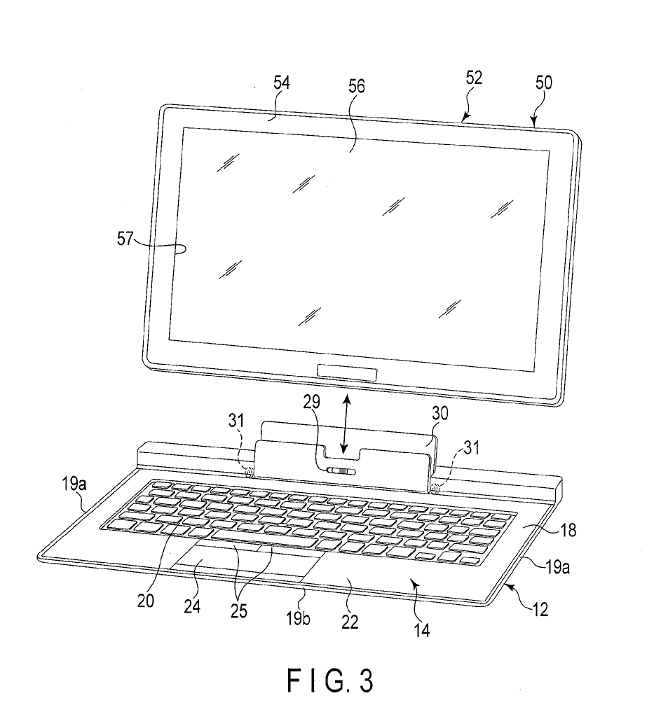

FIG. 1 is a perspective view illustrating a notebook type portable computer as an electronic apparatus in the embodiment. FIG. 2 is a perspective view of the portable computer as seen from its rear. FIG. 3 is an exploded perspective view of the portable computer in which a display unit is taken off.

As shown in FIGS. 1 and 2, a portable computer 10 comprises a first device 12 and a second device 50 supported on the first device. The first device 12 comprises a flat rectangular device body (case) 14. The device body 14 includes a rectangular bottom wall 16 and a rectangular top wall 18 opposite the bottom wall 16. The device body 14 further includes side walls 19a, a front wall 19b, and a rear wall 19c individually located along the side edges of each of the bottom wall and the top wall.

The top wall 18 has a substantially rectangular opening 19 stretching from the central region to the rear half region of the top wall 18. A keyboard 20 is placed in the opening 19 and is exposed to the view. The front half region of the top wall 18 constitutes a palm rest 22. A touchpad 24 and click switches 25 are provided at the central region of the palm rest 22. The touchpad 24 is configured to operate a pointing device. At the rear wall 19c are provided various connectors and terminals, such as a USB connector 26, an HDMI (registered trademark) output connector 27, an RGB connector 28, and so forth. A control circuit board, which is not shown, for controlling the keyboard 20, the touchpad 24, and so forth is arranged in the device body 14. The USB connector 26, the HDMI output connector 27, the RGB connector 28, etc., are mounted on the control circuit board.

A holder (a dock) 30 that is capable of holding the second device 50 is provided at the intermediate region of its rear end of the top wall 18. The holder 30 extends for a predetermined length in a width direction of the top wall 18. The holder 30 is supported on the device body 14 to be rotatable about an axis extending in the width direction of the top wall 18 by a pair of right and left hinges 31. The left and right hinges 31 are apart from each other in the width direction of the top wall 18c. The holder 30 has a U-shaped cross-section, and is open at its top. A connector (not shown) is provided in the holder 30 and connected to the aforementioned control circuit board.

In this way, the first device 12 is constructed as what is called a keyboard dock.

The second device 50 is constructed as a display unit 52 comprising a display. The display unit 52 comprises a flat rectangular case (device body) 54 and a rectangular liquid crystal display panel (display) 56 provided in the case 54. The liquid crystal display panel 56 includes a display screen exposed at a display window 57 formed at the case 54. The liquid crystal display panel 56 is constructed as a tablet type display panel having touch-sensors or a touch-panel 55 opposite to the display panel.

With the present embodiment, in the case 54 are provided a non-illustrated control circuit board, a storage device such as an HDD, an SSD, or the like, a battery, a piece of communication equipment, and so forth. Various connectors and terminals are provided at the side surfaces of the case 54. In this way, the display unit 52 is constructed as a tablet type portable computer.

As illustrated in FIGS. 1 and 2, the display unit 52 is detachably docked with (fitted in) the holder 30 of the first device 12. The display unit 52 is held by the holder 30 and the device body 14 and rotatable between a closed position to cover the upper surface of the device body 14 and an open position to expose the upper surface of the device body 14 and the display screen. The display unit 52 is connected to the connector in the holder 30, and is electrically connected to the first device 12 through the connector.

An operation of a release lever 29 on the holder 30 as shown in FIG. 3 allows removal of the display unit 52 from the holder 30. In the present embodiment, the removed display unit 52 can be used as a tablet type portable computer.

The first device 12 comprises a tilt structure to tilt the device body 14 at a predetermined angle and a pull-out support stand (stand) 40 to prevent the device body 14 from tipping over.

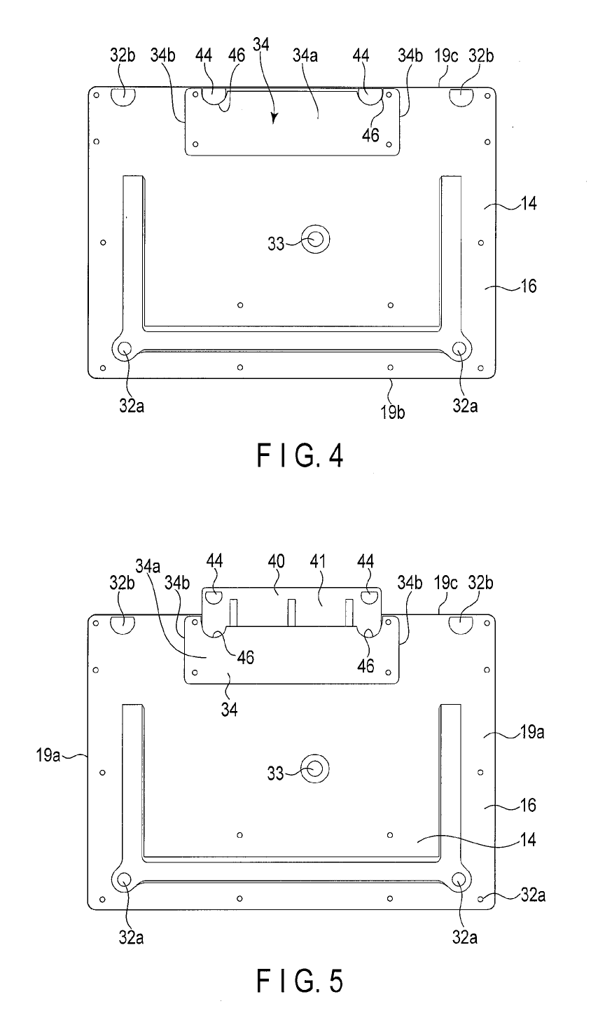

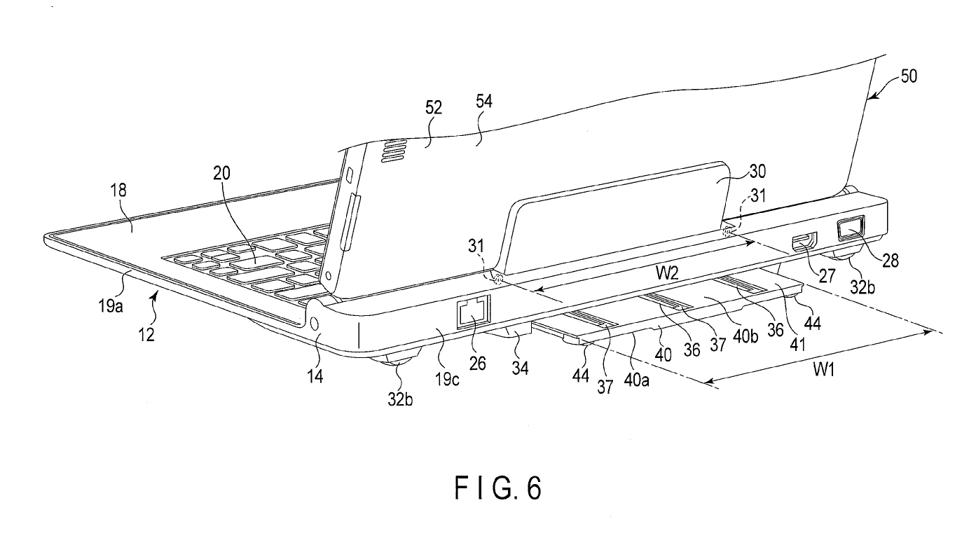

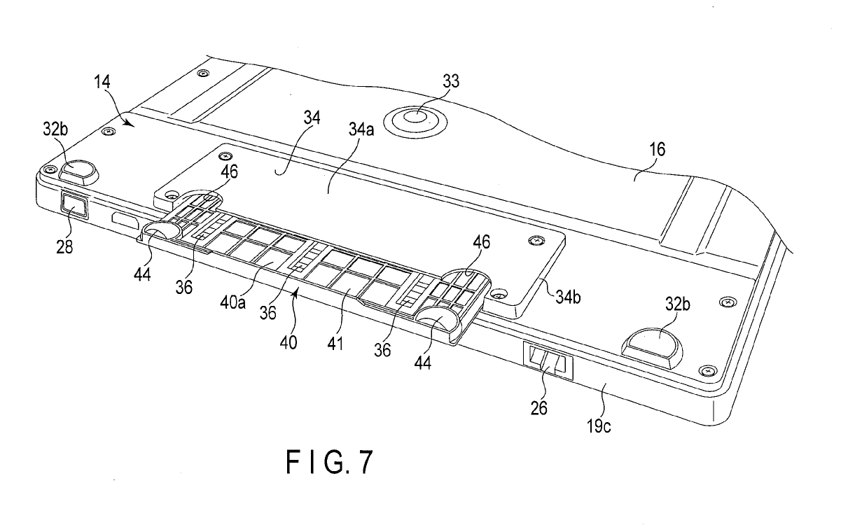

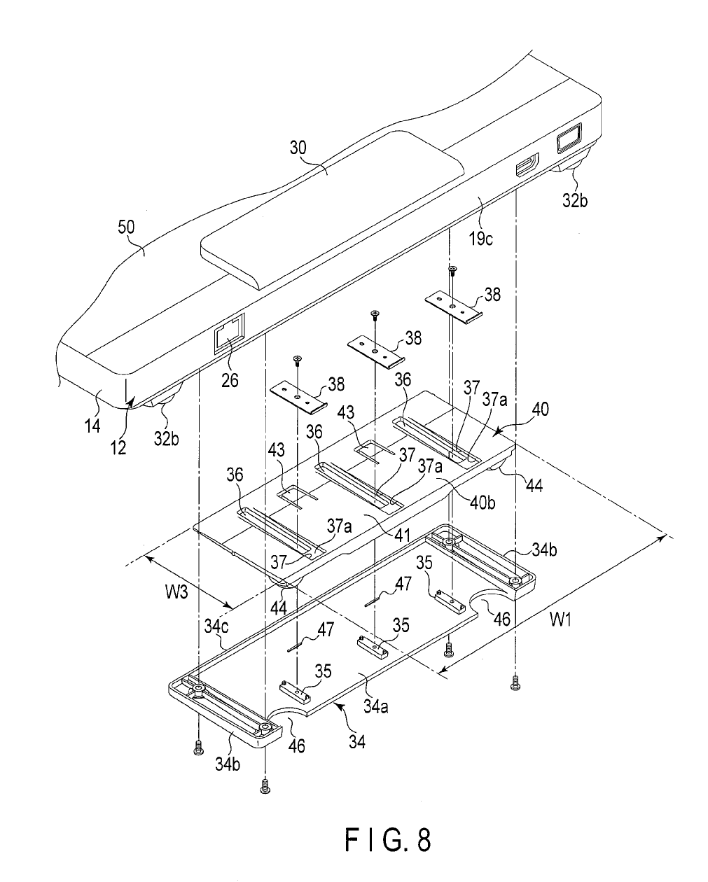

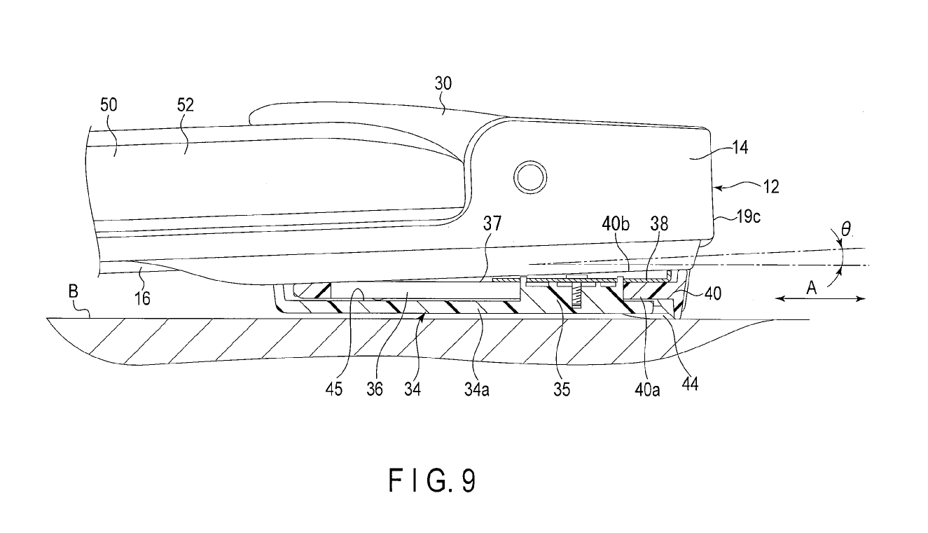

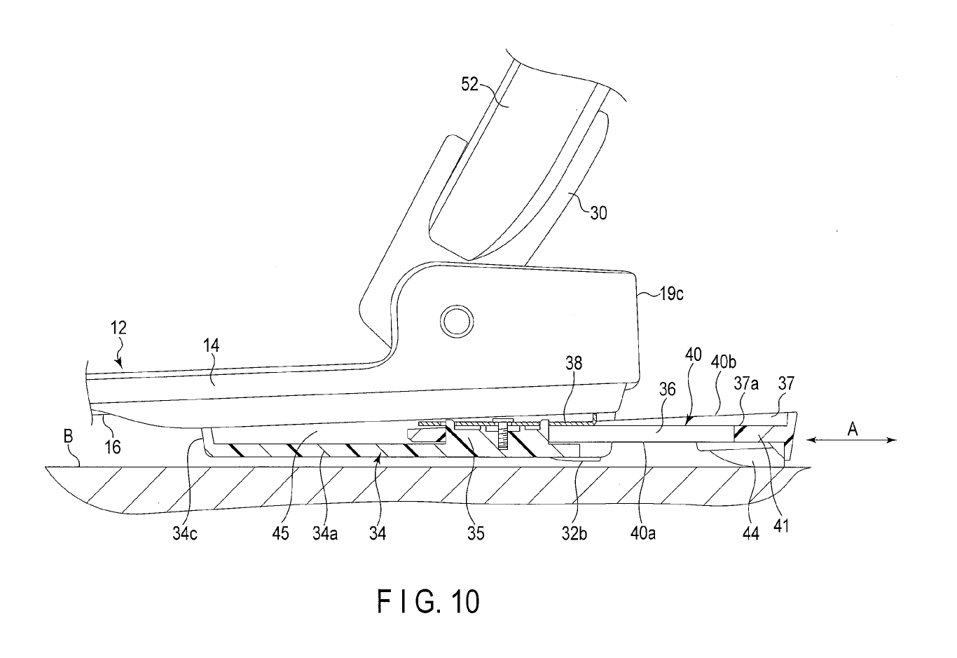

FIG. 4 and FIG. 5 individually are a plan view illustrating the bottom of the device body 14. FIG. 6 is a perspective view illustrating the rear part of the portable computer 10 in a state that the support stand 40 has been pulled out. FIG. 7 is a perspective view illustrating the rear part of the bottom of the portable computer 10 in a state that the support stand has been pulled out. FIG. 8 is an exploded perspective view illustrating a disassembled support stand portion. FIG. 9 and FIG. 10 respectively are a cross-sectional view of the support stand in a stored position and a cross-sectional view of the support stand in a pulled out position.

As shown in FIGS. 4 to 7, the device body 14 comprises as a tilt structure a plurality of legs on the bottom wall 16 of the device body 14. More specifically, the device body 14 comprises a pair of front legs 32a on the two respective corners of the front end side of the bottom wall 16, and a pair of rear legs 32b on the two respective corners of the rear end side of the bottom wall 16. The rear legs 32b are formed higher than the front legs 32a in projection height. Furthermore, the device body 14 is made in such a manner that its rear part is a little thicker than its front part. Therefore, as illustrated in FIGS. 6 and 9, when the device body 14 is placed on a mounting surface B, such as the top surface of a desk, it will tilt (incline) at a tilt angle e, for instance 2 degrees, to the mounting surface B. The device body 14 tilts in such a manner that its front part will be lower whereas its rear part will be higher.

As illustrated in FIGS. 4 and 5, the device body 14 comprises an auxiliary leg 33 at a central part of the bottom wall 16 of the device body 14. The auxiliary leg 33 normally does not abut to the mounting surface B, but it will abut on the mounting surface B and will support the device body 14 when the device body 14 is bent at its central part towards the mounting surface upon tapping on the keyboard 20.

Now, the pull-out support stand 40 will be explained. As illustrated in FIGS. 6 to 10, the support stand 40 comprises a plate-shaped body 41 formed as a rectangular plate. The body 41 of the support stand 40 has a flat rectangular lower surface 40a and a flat rectangular upper surface 40b opposite the lower surface 40a. The upper surface 40b has a tilt tilting at the tilt angle θ, for instance, with respect to the lower surface 40a. The support stand 40 thus has a wedge shape at its cross section, namely, the support stand 40 is formed in such a manner that its front end (a pushed in) side is thinner whereas its rear end (a pulled out) side is thicker. The longitudinal dimension W1 of the support stand 40 is formed longer than the distance W2 between the hinges 31, whereas the width dimension W3 of the support stand 40 is suitably set in accordance with the pulled out amount of the support stand 40.

A plurality of guide slits extending in the width direction, such as three guide slits 36 for instance, are formed in the body 41 of the support stand 40. Moreover, a plurality of guide grooves, such as three guide grooves 37 for instance, are formed on the upper surface 40b of the support stand 40. The guide slits 36 are arranged apart from one another in the longitudinal direction of the support stand 40, with one of the guide slits 36 being located at a middle region in the longitudinal direction of the support stand 40 whereas the remaining two of the guide slits 36 being located at the respective longitudinal ends of the support stand 40. The guide grooves 37 are wider than the guide slits 36, and overlap the corresponding guide slits 36. Each of the guide grooves 37 has a bottom surface 37a extending parallel to the lower surface 40a of the support stand 40. Each of the guide grooves 37 therefore is formed to be gradually deeper in a direction from the front end to the rear end of the support stand 40

The support stand 40 integrally has two locking claws 43, each obtained by partially cutting the body 41 of the support stand 40 in a shape of a letter U. The support stand 40 has a pair of right and left supporting legs 44 protrusively provided on the two respective corners of the rear end side of the lower surface 40a of the body 41. The distance between the supporting legs 44 is set longer than the distance W2 between the above-mentioned pair of hinges 31.

The support stand 40 is arranged at the middle region of the rear end of the device body 14 in such a manner that the lower surface 40a faces and is parallel to the mounting surface B and that the longitudinal direction of the support stand 40 is consistent with the width direction of the device body 14. The support stand 40 is slidably held on the supporting wall of the device body 14, so that it may slide parallel to the mounting surface B.

In the present embodiment, the device body 14 has a flat rectangular cover 34 fixed to the outer surface of the bottom wall 16. The cover 34 constitutes the supporting wall. Namely, the cover 34 is integrally formed of a synthetic resin as a unitary component, and has a flat rectangular supporting wall 34a larger in size than the support stand 40, a pair of side walls 34b protrusively provided at the respective two ends of the supporting wall 34a, and a front wall 34c protrusively provided at the front end of the supporting wall 34a. The cover 34 is open at its rear end. Each of the side walls 34b has an upper edge, which inclines with respect to the supporting wall 34a and has an inclination from the front end to the rear end of the supporting wall 34a. Namely, teach of the side walls 34b has an upper end that extends with tilting at the tilt angle θ with respect to the supporting wall 34a.

The cover 34 is fixed to the middle region of the rear end of the bottom wall 16 in such a manner that the respective upper edges of the side walls 34b and the upper edge of the front wall 34c abut against the outer surface of the bottom wall 16 of the device body 14. The longitudinal direction of the cover 34 is consistent with the width direction of the device body 14. Accordingly, the supporting wall 34a of the cover 34 will be parallel to the mounting surface B, and a storage chamber 45 for storing or housing the support stand 40 is defined by the bottom wall 16 and the inner surface of the cover 34. The rear end opening of the cover 34 is substantially in alignment with the rear end of the bottom wall 16 of the device body 14. It is the rear end opening that allows the insertion and extraction of the support stand 40 to and from the storage chamber 45 of the cover 34.

As illustrated in FIGS. 8 to 10, a pair of notches 46 for accommodating the corresponding supporting legs 44 of the support stand 40 is formed at the rear end of the supporting wall 34a of the cover 34. Three rectangular guide bosses (guide ribs) 35 project from the inner surface of the supporting wall 34a. The three guide bosses 35 are arranged to correspond to the three guide slits 36 of the support stand 40. Each of the guide bosses 35 has substantially the same width as the corresponding one of the guide slits 36. Two engaging projections 47 are formed on the inner surface of the supporting wall 34a.

The support stand 40 is mounted on the supporting wall 34a in such a manner that the three guide bosses 35 are correspondingly inserted into the three guide slits 36 and that the lower surface 40a of the support stand 40 faces the supporting wall 34a. A holding plate 38 made of a rectangular metal plate is attached to the projecting end of each guide boss 35. The holding plate 38 is larger in area than the corresponding guide boss 35, and is not only fit in a corresponding one of the guide grooves 37 but also abuts on the bottom 37a of the guide groove 37.

The support stand 40 is held by the holding plates 38 with the lower surface 40a of the support stand being contact with the supporting wall 34a, and is guided by the guide bosses 35 and guide slits 36 to be slidable along the supporting wall 34a. The support stand 40 is capable of sliding parallel to the supporting wall 34a or the mounting surface B between a stored position where the support stand 40 is stored or housed in the device body 14, e.g., in the storage chamber 45 of the cover 34 in this embodiment, as illustrated in FIGS. 2, 4 and 9 and a pulled out position where the support stand 40 is pulled out rearward by a predetermined distance from the device body 14 as illustrated in FIGS. 5, 7 and 10.

As shown in FIG. 9, the support stand 40 is formed to have a wedge-shaped cross section, so that the support stand 40 is snugly stored in the storage chamber 45, when it is in the stowed position, in such a manner that the lower surface 40a abuts on the supporting wall 34a and that the upper surface 40b abuts on the bottom wall 16. In addition, the locking claws 43 of the support stand 40 engage with the engaging projections 47 of the supporting wall 34a and thus the support stand 40 will be locked in the stored position. Even in the stored position, the supporting legs 44 of the support stand 40 project downwards through the notches 46 of the cover 34 and abut on the mounting surface B.

In the pulled out position, the support stand 40 faces and is parallel to the mounting surface B, and the pair of supporting legs 44 abut on the mounting surface B, as illustrated in FIG. 10. The support stand 40 supports the rear end of the device body 14, and prevents the device body 14 from tipping over or the front end from rising. A load imposed on the supporting legs 44 will be transmitted to the support stand 40, and thus will be sustained by the holding plates 38, the bottom wall 16 of the device body 14 and the supporting wall 34a of the cover 34.

The portable computer 10 as structured above comprises the support stand 40, which can be pulled out from the device body 14, and the support stand 40 makes it possible to prevent the device body 14 and the display unit 52 from tipping over. The provision of the support stand 40 not only eliminates the user from changing the tilt angle of the first device, but also keeps to a minimum an increase in weight of the first device, resulting in prevention of the portable computer from tipping over without loss of portability.

The support stand 40 is configured to slide in a direction parallel to the mounting surface, so that the support stand will never move away from the mounting surface even if the support stand is pulled out. Therefore, it is possible to keep the supporting legs of the support stand abutting on the mounting surface whether the support stand is in the stored position or in the pulled out position. The portable computer can be stably supported without ricketiness and surely prevented from tipping over by the support stand pulled out to the pulled out position.

Since the device body incorporates the slidable support stand, it is possible without deterioration of designability and portability to keep to a minimum an increase in weight of the first device and to prevent the device body from tipping over. When the width (length) of the support stand 40 and the distance between the supporting legs 44 are made larger (wider) than the distance between the pair of the hinges 31 swingably supporting the display unit, the support stand will surely support the first device and prevent any turnover more surely than ever even if any force may act through the hinges on the device body when the display unit is made open or closed. As having been explained above, the present embodiment makes it possible to obtain an electronic apparatus which surely prevents its device body from tipping over.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For instance, the supporting wall of the device body in the embodiment having been explained above is made of the cover. However, the supporting wall is not necessarily made of the cover, but may be formed by tilting a part of the bottom wall of the device body in order to make the part parallel to the mounting surface. Furthermore, the second device is not limited to such a device that is detachably attached to the first device, but the second device may be fixed to or non-removably supported on the first device. Electronic apparatus is not limited to the aforementioned portable computer, but other various pieces of electronic apparatus may be applicable.

What is claimed is:

1. An electronic apparatus comprising:
a device body comprising a bottom wall and a rear wall, and a plurality of legs on the bottom wall configured to support the device body on a mounting surface at a tilt angle to the mounting surface;
a display rotatably supported on the device body; and
a support stand in the device body configured to be movable in a direction substantially parallel to the mounting surface between a stored position wherein the support stand is housed in the device body and a pulled out position wherein the support stand is pulled out rearward from the rear wall of the device body to support the device body.

2. The electronic apparatus of claim 1, wherein the support stand comprises a plate-shaped body opposite and substantially parallel to the mounting surface, and a supporting leg projecting from the plate-shaped body and configured to abut on the mounting surface at either the stored position or the pulled out position.

3. The electronic apparatus of claim 1, wherein the device body comprises a supporting wall opposite and substantially parallel to the mounting surface, wherein the supporting wall slidably supports the support stand.

4. The electronic apparatus of claim 1, wherein the device body comprises a keyboard.

5. The electronic apparatus of claim 1, wherein the device body comprises a holder rotatably supported by a pair of hinges on the rear wall of the device body and configured to detachably hold the display.

6. The electronic apparatus of claim 5, wherein the support stand comprises a plate-shaped body opposite and substantially parallel to the mounting surface, and a supporting leg projecting from the plate-shaped body and configured to abut on the mounting surface at either the stored position or the pulled out position, a width of the plate-shaped body in a width direction of the device body is larger than a distance between the pair of hinges.

7. The electronic apparatus of claim 5, wherein the display comprises a tablet type display, and the tablet type display comprises a display panel and either touch-sensors or a touch-panel opposite to the display panel.

8. The electronic apparatus of claim 2, wherein the device body comprises a supporting wall opposite and substantially parallel to the mounting surface, wherein the supporting wall slidably supports the support stand.

9. The electronic apparatus of claim 8, wherein the device body comprises a keyboard.

10. The electronic apparatus of claim 2, wherein the device body comprises a holder rotatably supported by a pair of hinges on the rear wall of the device body and configured to detachably hold the display.

11. An electronic apparatus comprising:
a device body comprising a bottom wall and a rear wall;
a plurality of legs on the bottom wall configured to support the device body on a mounting surface at a tilt angle to the mounting surface; and
a support stand in the device body configured to be movable in a direction substantially parallel to the mounting surface between a stored position wherein the support stand is housed in device body and a pulled out position wherein the support stand is pulled out rearward from the rear wall of the device body to support the device body.

12. The electronic apparatus of claim 11, further comprising a holder rotatably supported by a pair of hinges on the rear wall of the device body and configured to detachably hold a display.

13. The electronic apparatus of claim 11, further comprising a keyboard on the device body.

14. The electronic apparatus of claim 11, wherein the support stand comprises a plate-shaped body opposite and substantially parallel to the mounting surface, and a supporting leg projecting from the plate-shaped body and configured to abut on the mounting surface at either the stored position or the pulled out position.

15. The electronic apparatus of claim 14, wherein the device body comprises a supporting wall opposite and substantially parallel to the mounting surface, wherein the supporting wall slidably supports the support stand.
